(19) United States
(12) Patent Application Publication
(10) Pub. No.: US 2020/0248906 A1
(43) Pub. Date: Aug. 6, 2020

(54) ROTATING DETONATION COMBUSTOR WITH NON-CIRCULAR CROSS-SECTION

(71) Applicant: General Electric Company, Schenectady, NY (US)

(72) Inventors: Kapil Kumar Singh, Rexford, NY (US); Narendra Digamber Joshi, Schenectady, NY (US); Joel Meier Haynes, Schenectady, NY (US); Venkat Eswarlu Tangirala, Niskayuna, NY (US); Meghan Borz, North Charleston, SC (US)

(73) Assignee: General Electric Company, Schenectady, NY (US)

(21) Appl. No.: 16/267,469

(22) Filed: Feb. 5, 2019

(51) Int. Cl. F23R 7/00; F02C 3/16; F23R 3/00; F23R 3/04; F23R 3/28

(52) U.S. Cl. CPC F23R 7/00; F02C 3/16; F05D 2240/35; F23R 3/04; F23R 3/28; F23R 3/002

(57) ABSTRACT

A rotating detonation combustor includes an annular combustion passage that is non-circular. Specifically, the present rotating detonation combustor includes a forward wall, a radially inner wall, and a radially outer wall. The radially inner wall and the radially outer wall extend downstream from the forward wall around a longitudinal axis of the combustor, thus defining an annular passage between the radially inner wall and the radially outer wall. An air inlet and a fuel inlet are disposed proximate to the forward wall and in fluid communication with the annular passage. The cross-section of the annular passage, which can be elliptical or polygonal, is defined by arcuate and/or straight sides of the inner and outer walls.

### TECHNICAL FIELD

The present disclosure relates generally to the field of gas turbine engines and, more particularly, to rotating detonation combustors with a non-circular cross-section.

### BACKGROUND

Some conventional turbo machines, such as gas turbine systems, are utilized to generate electrical power or to provide propulsion for aircraft. In general, gas turbine systems include a compressor, a combustor, and a turbine. Air may be drawn into a compressor, via its inlet end, where the air is compressed by passing through multiple stages of rotating blades and stationary nozzles. The compressed air is mixed with fuel and burned in a combustor, and the resulting combustion products (hot gases) are directed to a turbine to convert the thermal and kinetic energy into work.

Rotating detonation combustors, which are currently the subject of considerable worldwide research, are believed to offer an efficiency benefit over pulse detonation combustors and conventional deflagrative combustors. The combustion process begins when a fuel/oxidizer (e.g., air) mixture in a tube or pipe structure is ignited via a spark or another suitable ignition source to generate a compression wave. The compression wave is followed by a chemical reaction that transitions the compression wave to a detonation wave. The detonation wave travels circumferentially and axially through the combustion chamber defined by the tube. As air and fuel are fed into the combustion chamber, they are consumed by the detonation wave. As the detonation wave consumes air and fuel, combustion products traveling along the combustion chamber accelerate and are discharged from the combustion chamber.

Specifically, as shown in FIG. 1, a rotating detonation combustor 2 includes an inner wall 6 and an outer wall 8 that together define an annular passage 4. The combustor 2 has an inlet end 10 defined by a forward wall 14 and into which the compressed air from the compressor (not shown) is introduced for mixing with fuel. Once ignited at the detonation front 16, the fuel and air mixture 12 produces one or more self-sustaining detonation waves that travel in a circumferential direction 15 as an oblique shock wave 18 through the annular passage 4 (i.e., around a longitudinal axis of the combustor 2) and that provide a high-pressure region 16 proximate to the detonation front 16. As the waves 18 travel through the annulus 4, the incoming reactant fill 13 is consumed, which helps to push the combustion products 22 from the annular passage 4. The combustion products 22 exit the combustor 2, via the outlet end 20, for delivery to the turbine (not shown).

The combustion products 22 flow through a fluid flow path in a turbine, which is defined between a plurality of rotating blades and a plurality of stationary nozzles disposed between the rotating blades, such that each set of rotating blades and each corresponding set of stationary nozzles defines a turbine stage. Typically, the rotation of the turbine blades also causes rotation of the compressor blades, which are coupled to the rotor.

In the development of rotating detonation combustors, computer modeling has generally used a circular cross-section to represent the annulus 4 between the inner wall 6 and the outer wall 8. However, it has been found that this circular architecture inhibits the efficient delivery of the combustion products 22 to the turbine section. Therefore, architectures having a shape more complementary to the inlet of the turbine section are desirable.

### SUMMARY

The present disclosure is directed to a rotating detonation combustor in which the cross-section of the annular combustion passage is non-circular. Specifically, the present rotating detonation combustor includes a forward wall, a radially inner wall, and a radially outer wall. The radially inner wall and the radially outer wall extend downstream from the forward wall around a longitudinal axis of the combustor, thus defining an annular passage between the radially inner wall and the radially outer wall. An air inlet and a fuel inlet are disposed proximate to the forward wall and in fluid communication with the annular passage. The cross-section of the annular passage, which can be elliptical or polygonal, is defined by arcuate and/or straight sides of the inner and outer walls.

### BRIEF DESCRIPTION OF THE DRAWINGS

The specification, directed to one of ordinary skill in the art, sets forth a full and enabling disclosure of the present system and method, including the best mode of using the same. The specification refers to the appended figures, in which:

FIG. 1 is schematic illustration of a rotating detonation combustor, according to conventional practice;

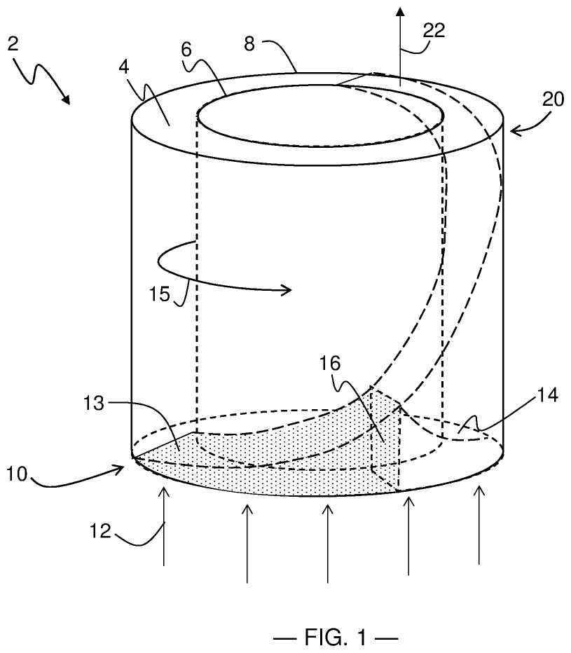

FIG. 2 is schematic cross-section of a rotating detonation combustor, according to one aspect of the present rotating detonation combustor;

FIG. 3 is a schematic illustration of a first exemplary rotating detonation combustor, as in FIG. 2, which is provided with an oval cross-section, according to a first aspect of the present disclosure;

FIG. 4 is a perspective view of the rotating detonation combustor of FIG. 3;

FIG. 5 is a schematic illustration of an inlet end of a second exemplary rotating detonation combustor, as in FIG. 2, which is provided with a racetrack-shaped cross-section, according to a second aspect of the present disclosure;

FIG. 6 is a perspective view of the rotating detonation combustor of FIG. 5;

FIG. 7 is a schematic illustration of an inlet end of a third exemplary rotating detonation combustor, as in FIG. 2, which is provided with a triangular cross-section, according to a third aspect of the present disclosure;

FIG. 8 is a perspective view of the rotating detonation combustor of FIG. 7;

FIG. 9 is a schematic illustration of an inlet end of a fourth exemplary rotating detonation combustor, as in FIG. 2, which is provided with an elongated octagonal cross-section, according to a fourth aspect of the present disclosure;

FIG. 10 is a perspective view of the rotating detonation combustor of FIG. 9;

FIG. 11 is a schematic illustration of an inlet end of a fifth exemplary rotating detonation combustor, as in FIG. 2, which is provided with a rounded rectangular cross-section, according to a fifth aspect of the present disclosure; and

FIG. 12 is a perspective view of the rotating detonation combustor of FIG. 11.

### DETAILED DESCRIPTION

Reference will now be made in detail to various embodiments of the present disclosure, one or more examples of which are illustrated in the accompanying drawings. The detailed description uses numerical and letter designations to refer to features in the drawings. Like or similar designations in the drawings and description have been used to refer to like or similar parts of the disclosure.

To clearly describe the current rotating detonation combustor with a non-circular cross-section, certain terminology will be used to refer to and describe relevant machine components within the scope of this disclosure. To the extent possible, common industry terminology will be used and employed in a manner consistent with the accepted meaning of the terms. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single integrated part.

In addition, several descriptive terms may be used regularly herein, as described below. The terms “first”, “second”, and “third” may be used interchangeably to distinguish one component from another and are not intended to signify location or importance of the individual components.

As used herein, “downstream” and “upstream” are terms that indicate a direction relative to the flow of a fluid, such as the working fluid through the turbine engine. The term “downstream” corresponds to the direction of flow of the fluid, and the term “upstream” refers to the direction opposite to the flow (i.e., the direction from which the fluid flows). The terms “forward” and “aft,” without any further specificity, refer to relative position, with “forward” being used to describe components or surfaces located toward the front (or compressor) end of the engine or toward the inlet end of the combustor, and “aft” being used to describe components located toward the rearward (or turbine) end of the engine or toward the outlet end of the combustor. The term “inner” is used to describe components in proximity to the turbine shaft or longitudinal axis of the combustor, while the term “outer” is used to describe components distal to the turbine shaft or longitudinal axis of the combustor.

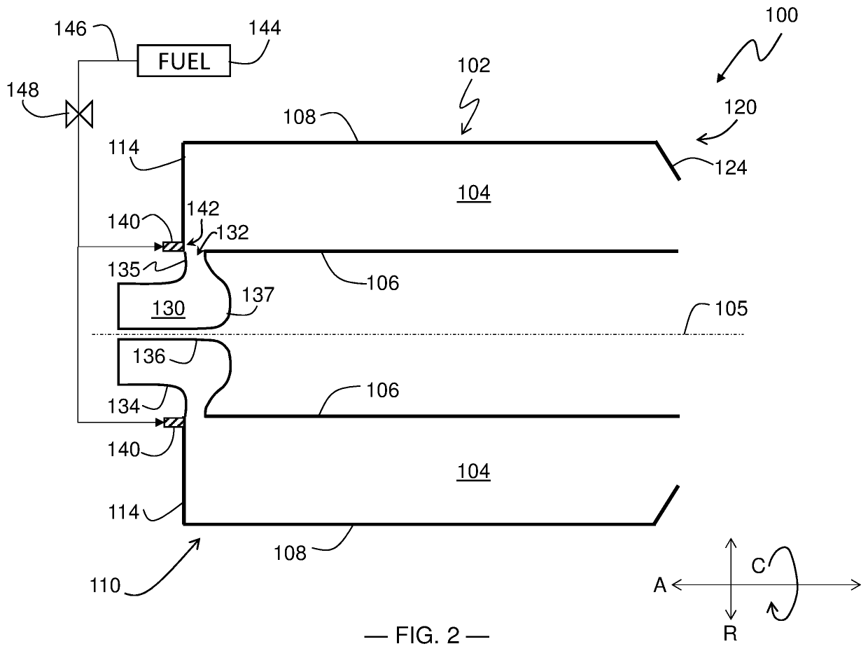

It is often required to describe parts that are at differing radial, axial and/or circumferential positions. As shown in FIG. 2, the “A” axis represents an axial orientation. As used herein, the terms “axial” and/or “axially” refer to the relative position/direction of objects along axis A, which is substantially parallel with the axis of rotation of the gas turbine system. As further used herein, the terms “radial” and/or “radially” refer to the relative position or direction of objects along an axis “R”, which intersects axis A at only one location. In some embodiments, axis R is substantially perpendicular to axis A. Finally, the term “circumferential” refers to movement or position around axis A (e.g., axis “C”). The term “circumferential” may refer to a dimension extending around a center of a respective object (e.g., a rotor).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

Although exemplary embodiments of the present disclosure will be described generally in the context of rotating detonation combustors for use in aircraft propulsion for purposes of illustration, one of ordinary skill in the art will readily appreciate that embodiments of the present disclosure may be applied to land-based power-generating gas turbines as well.

Referring now to the drawings, FIG. 2 illustrates a side view of a rotating detonation combustor 100, according to various embodiments disclosed herein. The combustor 100 includes a combustion tube 102 extending between an inlet end 110 and an outlet end 120. The combustion tube 102 includes an inner wall 106 and an outer wall 108 radially spaced from, and circumferentially surrounding, the inner wall 106 to define an annular passage 104 therebetween.

In the present embodiments, the annular passage (e.g., 104) is symmetrical about a centerline 105, or longitudinal axis, of the combustor 100, which may be co-linear with the engine centerline. In this context, the term “annular” is not limited to a passage defining a circular cross-section. Rather, the term “annular” broadly encompasses any unobstructed passage of any shape that circumferentially surrounds the centerline 105 and that defines a passage through which a fluid (e.g., combustion products) may flow.

The inlet end 110 of the combustor 100 includes a forward wall 114, while the outlet end 120 includes an aft wall 124. The forward wall 114 defines the upstream boundary of the annular passage 104, while the aft wall 124 defines the downstream boundary of the annular passage 104.

A plenum 130 is fluidly coupled to the combustor tube 102 upstream of a fluid inlet 132 for delivering air, oxidizer, or other fluids to the annular passage 104. In the illustrated embodiment, the plenum 130 is an air plenum, which receives air from an air supply (such as a compressor, not shown). However, the plenum 130 may instead deliver a mixture of fuel and air into the annular passage 104.

The plenum 130 is defined within a first sidewall 134 (that defines a radially outer boundary of the plenum 130), a second sidewall 136 (that defines a radially inner boundary of the plenum 130), and a plenum end wall 137 (that defines an axially aft boundary of the plenum 130). Each of the first and second sidewalls 134, 136 extend in an axial, or substantially axial, direction. A curved transition portion 135 extends between the first sidewall 134 and the forward wall 114 of the combustor tube 102. The plenum end wall 137 extends between the second sidewall 136 and the inner wall 106 of the combustor tube 102. Specifically, the plenum end wall 137 defines a curved surface extending from the second sidewall 136, which includes a concave portion that opens in the direction of fluid flow into the plenum 130. The curved surface of the plenum end wall 136 forms a generally radial transition to the fluid inlet 132 at the inlet end 110 of the combustor tube 102.

Fuel injectors 140 may be disposed in a circumferential array through the forward wall 114 positioned at a radial location corresponding to the fluid inlet 132. The fuel injectors 140 may be disposed in the forward wall 114 that is axially forward of the inner wall 106. The fuel injectors 140 disperse fuel from a fuel supply 144, via fuel inlets 142, into the inlet air, as the inlet air flows in a radially outward direction through the fluid inlet 132 and into the combustor annular passage 104.

In the illustrated embodiment, the fuel inlets 142 disperse fuel in an axial direction, orthogonal to the direction of flow of the inlet air, which flows into the annulus 104 in a radially outward direction. A fuel line 146 fluidly couples the fuel supply 144 to the one or more fuel injectors 140 for deliver fuel to the one or more fuel injectors 140. A first fuel control valve 148 is fluidly coupled to the fuel line 146.

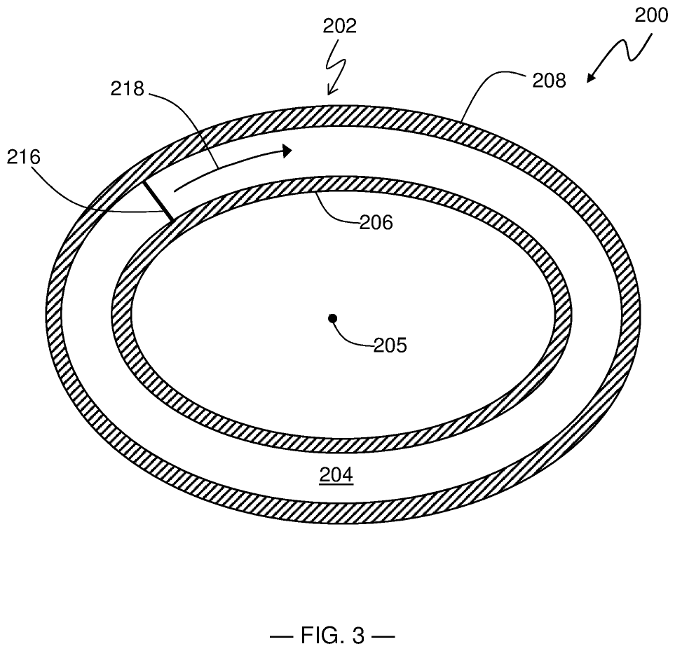

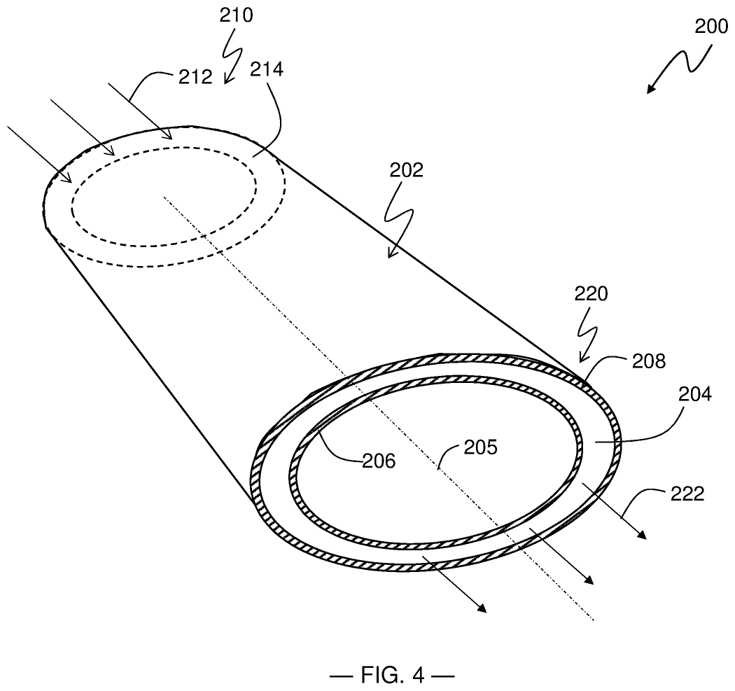

FIGS. 3 and 4 schematically illustrate a combustor 200 having a combustor tube 202 with an elliptical, or oval, cross-sectional shape. The combustor tube 202 includes an inner wall 206 and an outer wall 208, which define elliptical shapes that are disposed in concentric relationship around a longitudinal axis, or centerline, 205 of the combustor 200 to define an elliptical annular passage 204 between the inner wall 206 and the outer wall 208. The inner wall 206 and the outer wall 208 are connected at an inlet end 210 of the combustor 200 by a forward wall 214.

A fuel/oxidizer mixture 212 enters an inlet end 210 of the combustor 200 and is ignited. In this configuration, a detonation wave 218 originating from a detonation front 216 travels in a continuously curving path through the elliptical annular passage 204 to an outlet end 220, where the combustion products 222 exit the combustor tube 202. The outlet end 220 defines an elliptical annular passage in fluid communication with the elliptical annular passage 204.

Although the fuel/oxidizer mixture 212 is shown entering the inlet end 210 in an axial direction, it should be understood that the fuel/oxidizer mixture 212 may enter the inlet end 210 in a radial direction; that the fuel may be introduced in an axial direction through one or more fuel inlets, while the oxidizer (e.g., air) is introduced in a radial direction through one or more air inlets; or that the oxidizer (e.g., air) may be introduced in an axial direction through one or more air inlets, while the fuel is introduced in a radial direction through one or more fuel inlets.

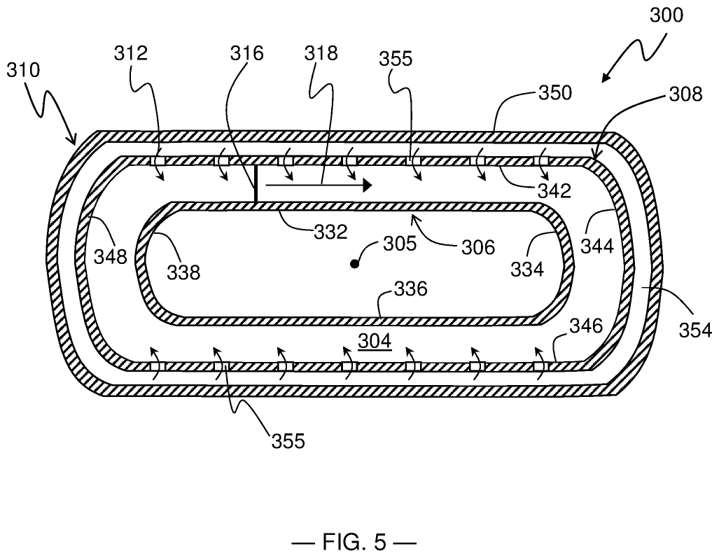

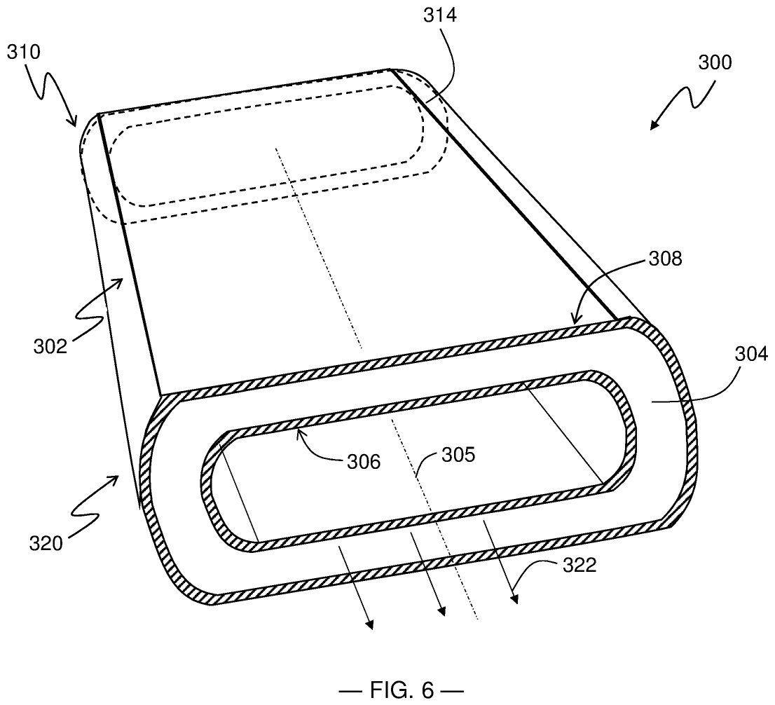

FIGS. 5 and 6 schematically illustrate a combustor 300 having a combustor tube 302 with a racetrack-shaped cross-section, according to a second aspect provided herein. The term “racetrack” refers to a shape having (or defined by) a pair of oppositely disposed, parallel sides, which are connected by respective arcuate segments.

Specifically, the combustor tube 302 includes an inner wall 306 and an outer wall 308. The inner wall 306 has a first straight side 332, a second straight side 336 opposite and parallel to the first straight side 332, a first curved segment 334 connecting a first end of the first straight side 332 to a corresponding first end of the second straight side 336, and a second curved segment 338 connecting a second end of the first straight side 332 to a corresponding second end of the second straight side 336. The outer wall 308 is similarly constructed with a first straight side 342, a first curved segment 344 extending from a first end of the first straight side 342, a second straight side 346 opposite and parallel to the first straight side 342 and connected to the first curved segment at a first end, and a second curved segment 348 extending from a second end of the second straight side 346 to a second end of the first straight side 342.

The respective racetrack shapes defined by the inner wall 306 and the outer wall 308 are disposed in concentric relationship around a longitudinal axis, or centerline, 305 of the combustor 300 to define a racetrack-shaped annular passage 304 between the inner wall 306 and the outer wall 308. The inner wall 306 and the outer wall 308 are connected at an inlet end 310 of the combustor 300 by a forward wall 314 (shown in FIG. 6).

In the exemplary configuration shown in FIG. 5, an inlet end 310 of the combustor 300 is surrounded by a plenum wall 350 that defines a fluid plenum 354. The fluid plenum 354 may direct fuel, oxidizer, or a fuel/oxidizer mixture 312 in a radial (or substantially radial) direction into the combustor 300, via inlet ports 355 defined in the first straight side 342 and the second straight side 346 of the outer wall 308. No inlet ports 355 are provided in the curved segments 344, 348. For clarity, the plenum wall 350 and the fluid plenum 354 are omitted from FIG. 6.

The fuel/oxidizer mixture 312 enters an inlet end 310 of the combustor 300 and is ignited. In this configuration, a detonation wave 318 originating from a detonation front 316 travels in a continuously curving path through the racetrack-shaped annular passage 304 to an outlet end 320, where the combustion products 322 exit the combustor tube 302 (as in FIG. 6). The outlet end 320 defines a racetrack-shaped annular passage in fluid communication with the racetrack-shaped annular passage 304.

Although the fuel/oxidizer mixture 312 is shown entering the inlet end 310 in a radial direction, it should be understood that the fuel/oxidizer mixture 312 may enter the inlet end 310 in an axial direction; that the fuel may be introduced in an axial direction through one or more fuel inlets, while the oxidizer (e.g., air) is introduced in a radial direction through one or more air inlets; or that the oxidizer (e.g., air) may be introduced in an axial direction through one or more air inlets, while the fuel is introduced in a radial direction through one or more fuel inlets.

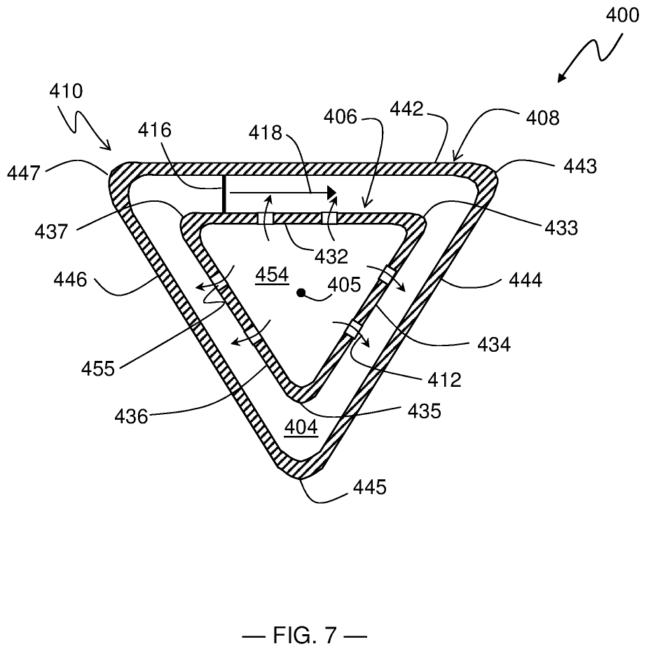

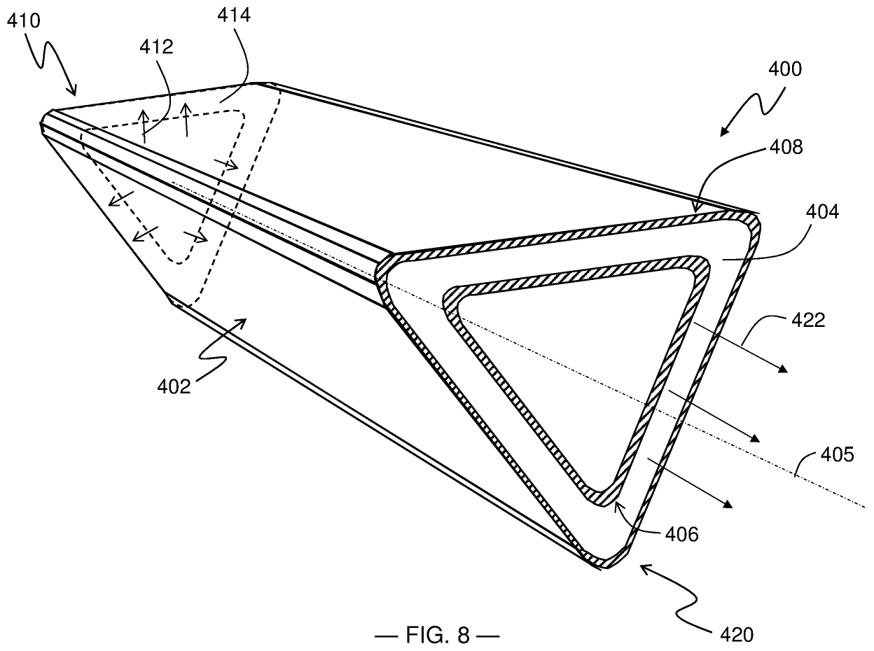

FIGS. 7 and 8 schematically illustrate a combustor 400 having a combustor tube 402 with a triangular cross-section, according to a third aspect provided herein. The term “triangular” refers to a shape having (or defined by) three straight sides, which are connected by respective arcuate segments at the corners.

Specifically, the combustor tube 402 includes an inner wall 406 and an outer wall 408. The inner wall 406 includes, in series, a first straight side 432, a first arcuate corner segment 433, a second straight side 434, a second arcuate corner segment 435, a third straight segment 436, and a third arcuate corner segment 437. The outer wall 408 is similarly constructed with a first straight side 442, a first arcuate corner segment 443, a second straight side 444, a second arcuate corner segment 445, a third straight segment 446, and a third arcuate corner segment 447, in series.

The respective triangular shapes defined by the inner wall 406 and the outer wall 408 are disposed in concentric relationship around a longitudinal axis, or centerline, 405 of the combustor 400 to define a triangular-shaped annular passage 404 between the inner wall 406 and the outer wall 408. The inner wall 406 and the outer wall 408 are connected at an inlet end 410 of the combustor 400 by a forward wall 414 (shown in FIG. 8).

In the exemplary configuration shown in FIG. 7, an inlet end 410 of the combustor 400 defines a fluid plenum 454, which may be located within the inner wall 406 and which may or may not include an additional plenum wall (such as plenum wall 350, shown in FIG. 5). The fluid plenum 454 may direct fuel, oxidizer, or a fuel/oxidizer mixture 412 in a radial (or substantially radial) direction into the combustor 400, via inlet ports 455 defined in the first straight side 432, the second straight side 434, and/or the third straight side 436 of the inner wall 406. No inlet ports 455 are provided in the curved segments 433, 435, and 437. For clarity, the fluid plenum 454 is omitted from FIG. 8.

The fuel/oxidizer mixture 412 enters an inlet end 410 of the combustor 400 and is ignited. In this configuration, a detonation wave 418 originating from a detonation front 416 travels in a continuously curving path through the triangular-shaped annular passage 404 to an outlet end 420, where the combustion products 422 exit the combustor tube 402 (as in FIG. 8). The outlet end 420 defines a triangular-shaped annular passage in fluid communication with the triangular-shaped annular passage 404.

Although the fuel/oxidizer mixture 412 is shown entering the inlet end 410 in a radial direction, it should be understood that the fuel/oxidizer mixture 412 may enter the inlet end 410 in an axial direction; that the fuel may be introduced in an axial direction through one or more fuel inlets, while the oxidizer (e.g., air) is introduced in a radial direction through one or more air inlets; or that the oxidizer (e.g., air) may be introduced in an axial direction through one or more air inlets, while the fuel is introduced in a radial direction through one or more fuel inlets.

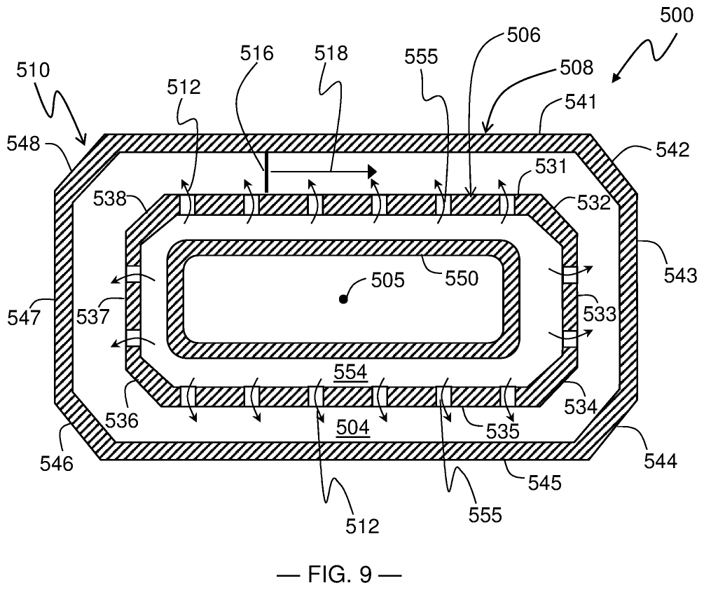

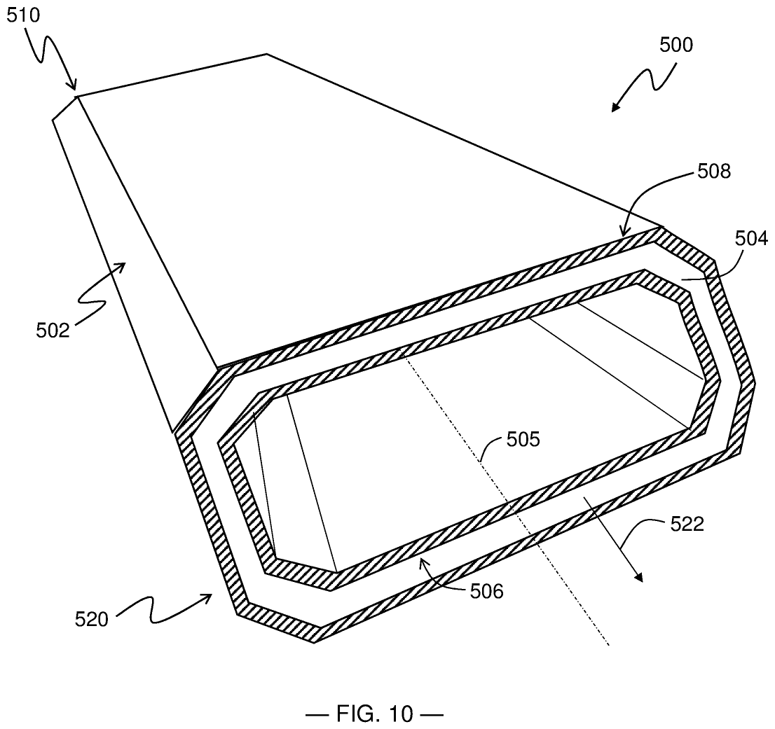

FIGS. 9 and 10 schematically illustrate a combustor 500 having a combustor tube 502 with an elongated octagonal cross-section, according to a fourth aspect provided herein. The term “elongated octagonal” refers to a shape having (or defined by) eight straight sides, in which a first set of opposing sides 531, 535 are longer than a second set of opposing sides 533, 537 and in which the first set of opposing sides 531, 535 and the second set of opposing sides 533, 537 are connected by corner sides 532, 534, 536, 538 that are shorter than each side in the first set of opposing sides 531, 535 and each side in the second set of opposing sides 533, 537.

Specifically, the combustor tube 502 includes an inner wall 506 and an outer wall 508. The inner wall 506 includes, in series, a first side 531, a first corner side 532, a second side 533, a second corner side 534, a third side 535 opposite the first side 531, a third corner side 536, a fourth side 537 opposite the second side 533, and a fourth corner side 538. The outer wall 508 is similarly constructed with a first side 541, a first corner side 542, a second side 543, a second corner side 544, a third side 545 opposite the first side 541, a third corner side 546, a fourth side 547 opposite the second side 543, and a fourth corner side 548, in series.

The respective octagonal shapes defined by the inner wall 506 and the outer wall 508 are disposed in concentric relationship around a longitudinal axis, or centerline, 505 of the combustor 500 to define an octagonal-shaped annular passage 504 between the inner wall 506 and the outer wall 508. The inner wall 506 and the outer wall 508 are connected at an inlet end 510 of the combustor 500 by a forward wall (not shown).

In the exemplary configuration shown in FIG. 9, an inlet end 510 of the combustor 500 defines a fluid plenum 554, which is located radially inward of the inner wall 506 and which is defined by a plenum wall 550. The fluid plenum 554 may direct fuel, oxidizer, or a fuel/oxidizer mixture 512 in a radial (or substantially radial) direction into the combustor 500, via inlet ports 555 defined in the first side 531, the second side 533, the third straight side 535, and/or the fourth side 537 of the inner wall 506. No inlet ports 555 are provided in the corner side walls 532, 534, 536, and 538. For clarity, the fluid plenum 554 is omitted from FIG. 10.

The fuel/oxidizer mixture 512 enters an inlet end 510 of the combustor 500 and is ignited. In this configuration, a detonation wave 518 originating from a detonation front 516 travels in a continuously curving path through the octagonal-shaped annular passage 504 to an outlet end 520, where the combustion products 522 exit the combustor tube 502 (as in FIG. 10). The outlet end 520 defines an octagonal-shaped annular passage in fluid communication with the octagonal-shaped annular passage 504.

Although the fuel/oxidizer mixture 512 is shown entering the inlet end 510 in a radial direction, it should be understood that the fuel/oxidizer mixture 512 may enter the inlet end 510 in an axial direction; that the fuel may be introduced in an axial direction through one or more fuel inlets, while the oxidizer (e.g., air) is introduced in a radial direction through one or more air inlets; or that the oxidizer (e.g., air) may be introduced in an axial direction through one or more air inlets, while the fuel is introduced in a radial direction through one or more fuel inlets.

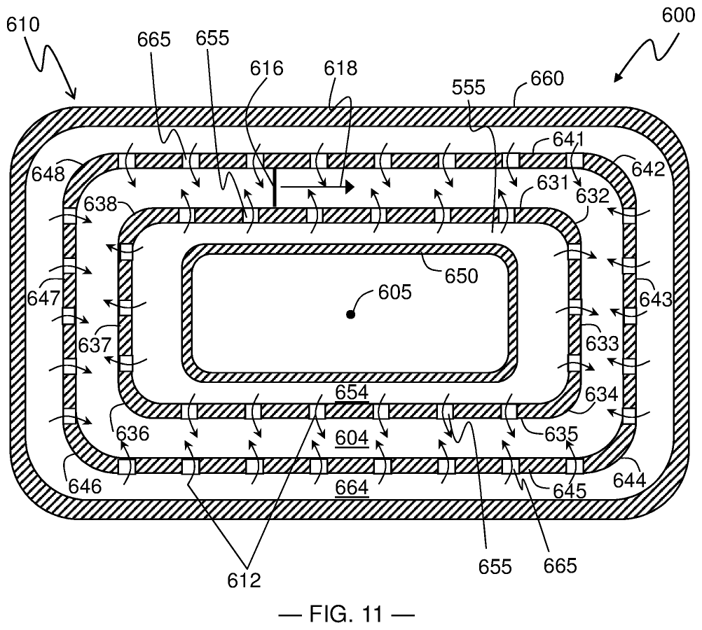

Further, although the plenum wall 550 is defined radially inward of the inner wall 506, it should be understood that the plenum wall 550 may instead by disposed radially outward of the outer wall 508 (in which case the fuel/air mixture 512 would be introduced in a radially inward direction). Alternately, plenums 554 may be disposed both radially inward and radially outward of the combustor tube 502 (as shown in FIG. 11).

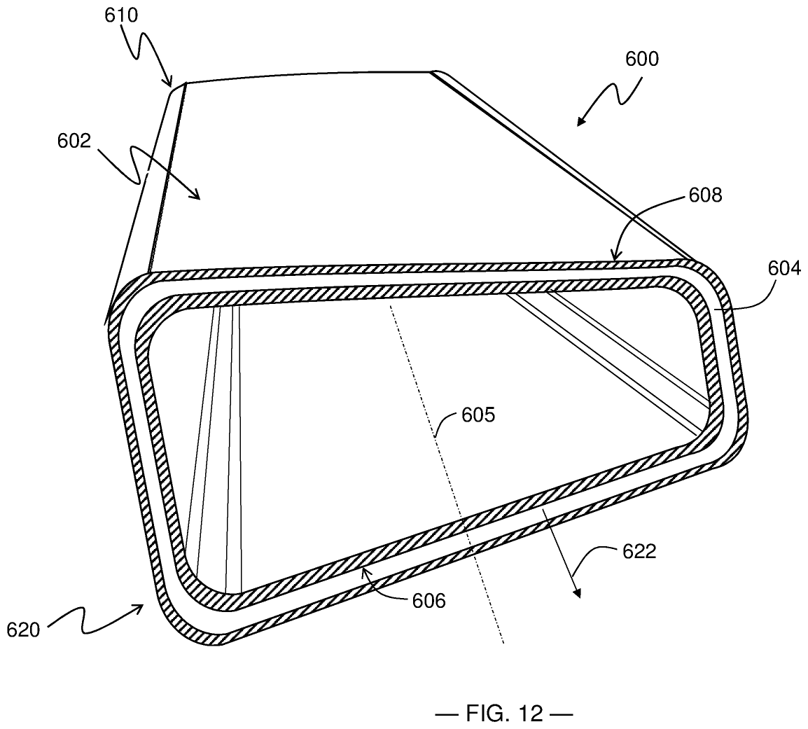

FIGS. 11 and 12 schematically illustrate a combustor 600 having a combustor tube 602 with a generally rectangular cross-section with rounded corners, according to a fifth aspect provided herein. The term “generally rectangular” refers to a shape having (or defined by) four straight sides, in which a first set of opposing sides 631, 635 are longer than a second set of opposing sides 633, 637 and in which the first set of opposing sides 631, 635 and the second set of opposing sides 633, 637 are connected by arcuate corner segments 632, 634, 636, 638 that are shorter than each side in the first set of opposing sides 631, 635 and each side in the second set of opposing sides 633, 637.

Specifically, the combustor tube 602 includes an inner wall 606 and an outer wall 608. The inner wall 606 includes, in series, a first side 631, a first arcuate corner segment 632, a second side 633, a second arcuate corner segment 634, a third side 635 opposite the first side 631, a third arcuate corner segment 636, a fourth side 637 opposite the second side 633, and a fourth arcuate corner segment 638. The outer wall 608 is similarly constructed with a first side 641, a first arcuate corner segment 642, a second side 643, a second arcuate corner segment 644, a third side 645 opposite the first side 641, a third arcuate corner segment 646, a fourth side 647 opposite the second side 643, and a fourth arcuate corner segment 648, in series.

The respective rectangular shapes defined by the inner wall 606 and the outer wall 608 are disposed in concentric relationship around a longitudinal axis, or centerline, 605 of the combustor 600 to define a generally rectangular-shaped annular passage 604 between the inner wall 606 and the outer wall 608. The inner wall 606 and the outer wall 608 are connected at an inlet end 610 of the combustor 600 by a forward wall (not shown).

In the exemplary configuration shown in FIG. 11, an inlet end 610 of the combustor 600 defines a first fluid plenum 654, which is located radially inward of the inner wall 606 and which is defined by a first plenum wall 650. The first fluid plenum 654 may direct fuel, oxidizer, or a fuel/oxidizer mixture 612 in a radial (or substantially radial) direction into the combustor 600, via inlet ports 655 defined in the first side 631, the second side 633, the third side 635, and/or the fourth side 637 of the inner wall 606. No inlet ports 655 are provided in the corner segments 632, 634, 636, and 638.

The inlet end 610 also includes a second fluid plenum 664, which is located radially outward of the outer wall 608 and which is defined by a second plenum wall 660. The second fluid plenum 664 may direct fuel, oxidizer, or a fuel/oxidizer mixture 612 in a radial (or substantially radial) direction into the combustor 600, via inlet ports 665 defined in the first side 641, the second side 643, the third side 645, and/or the fourth side 647 of the outer wall 608. No inlet ports 665 are provided in the corner segments 642, 644, 646, and 648. For clarity, the first fluid plenum 654 and the second fluid plenum 664 are omitted from FIG. 12.

The fuel/oxidizer mixture 612 enters an inlet end 610 of the combustor 600 and is ignited. In this configuration, a detonation wave 618 originating from a detonation front 616 travels in a continuously curving path through the generally rectangular-shaped annular passage 604 to an outlet end 620, where the combustion products 622 exit the combustor tube 602 (as in FIG. 12). The outlet end 620 defines a generally rectangular-shaped annular passage in fluid communication with the generally rectangular-shaped annular passage 604.

Although the fuel/oxidizer mixture 610 is shown entering the inlet end 610 in a radial direction, it should be understood that the fuel/oxidizer mixture 612 may enter the inlet end 610 in an axial direction; that the fuel may be introduced in an axial direction through one or more fuel inlets, while the oxidizer (e.g., air) is introduced in a radial direction through one or more air inlets; or that the oxidizer (e.g., air) may be introduced in an axial direction through one or more air inlets, while the fuel is introduced in a radial direction through one or more fuel inlets; or that the fuel may be introduced from one fluid plenum, while the oxidizer is introduced from the other fluid plenum. Further, although two plenums 654, 664 are illustrated, it should be understood that a single plenum (654 or 664) defined by a single plenum wall (650, 660, respectively) may instead be used.

Although the fluid plenums illustrated herein define a continuous annulus radially inward or radially outward of a respective combustor wall, it should be understood that the fluid plenums may be divided into two or more sub-plenums, if desired.

By providing the rotating detonation combustor with a non-circular cross-sectional annulus, the ability to direct the combustion gases into a turbine section of a gas turbine is significantly enhanced. The non-circular cross-sectional annulus may be elliptical or polygonal with the annulus being defined between inner and outer walls having curved sides or a combination of curved and straight sides. In those embodiments in which the inner and outer walls have both curved and straight sides, the fuel/air mixture is introduced through one or more fluid inlets defined through one or more of the straight sides.

Exemplary embodiments of the rotating detonation combustor with non-circular cross-section are described above in detail. The rotating detonation combustors described herein are not limited to the specific embodiments described herein, but rather, components of the rotating detonation combustor may be utilized independently and separately from other components described herein.

While the technical advancements have been described in terms of various specific embodiments, those skilled in the art will recognize that the technical advancements can be practiced with modification within the spirit and scope of the claims.

What is claimed is:

1. A rotating detonation combustor comprising:
a forward wall;
a radially inner wall extending downstream from the forward wall and surrounding a longitudinal axis;
a radially outer wall extending downstream from the forward wall, the radially outer wall surrounding the radially inner wall to define an annular passage between the radially inner wall and the radially outer wall; and
an air inlet and a fuel inlet disposed proximate to the forward wall and in fluid communication with the annular passage;
wherein the cross-section of the annular passage is non-circular.

2. The rotating detonation combustor of claim 1, wherein the fuel inlet is orthogonal to the air inlet.

3. The rotating detonation combustor of claim 1, wherein the cross-section of the annular passage is elliptical.

4. The rotating detonation combustor of claim 1, wherein the inner wall and the outer wall each comprise a plurality of straight wall segments; and wherein the cross-section of the annular passage comprises a plurality of straight passages disposed between the straight wall segments of the inner wall and the straight wall segments of the outer wall.

5. The rotating detonation combustor of claim 4, wherein the plurality of straight passages defines an elongated octagonal cross-section having eight straight passages.

6. The rotating detonation combustor of claim 1, wherein the inner wall and the outer wall each comprise a plurality of straight wall segments and a plurality of arcuate wall segments in an alternating series; and wherein the cross-section of the annular passage comprises an alternating series of straight passages and arcuate passages defined, respectively, between the straight wall segments and the arcuate wall segments of the inner wall and the outer wall.

7. The rotating detonation combustor of claim 6, wherein the alternating series of straight wall segments and arcuate wall segments in each of the inner wall and the outer wall defines a generally racetrack-shaped cross-section; and wherein the alternating series of straight wall segments and arcuate wall segments comprises a first straight side, a first arcuate side connected to the first straight side, a second straight side connected to the first arcuate side, and a second arcuate side extending between the second straight side and the first straight side.

8. The rotating detonation combustor of claim 6, wherein the alternating series of straight wall segments and arcuate wall segments in each of the inner wall and the outer wall defines a generally triangular cross-section; and wherein the alternating series of straight wall segments and arcuate wall segments comprises a first straight side, a first arcuate corner connected to the first straight side, a second straight side connected to the first arcuate corner, a second arcuate corner connected to the second straight side, a third straight side connected to the second arcuate corner, and a third arcuate corner extending between the third straight side and the first straight die.

9. The rotating detonation combustor of claim 6, wherein the alternating series of straight wall segments and arcuate wall segments of each of the inner wall and the outer wall defines an elongated octagonal cross-section having eight straight sides and eight arcuate corners.

10. The rotating detonation combustor of claim 6, wherein the fuel inlet comprises a plurality of fuel inlets; and wherein the fuel inlets are disposed in fluid communication only with the straight wall segments.

11. The rotating detonation combustor of claim 1, further comprising a first fluid plenum wall defining a first fluid plenum in communication with at least one of the air inlet and the fuel inlet.

12. The rotating detonation combustor of claim 11, wherein the first fluid plenum wall is radially inward of the radially inner wall.

13. The rotating detonation combustor of claim 12, wherein the first fluid plenum wall is radially outward of the radially outer wall.

14. The rotating detonation combustor of claim 11, further comprising a second fluid plenum wall defining a second fluid plenum in communication with at least one of the air inlet and the fuel inlet.

15. The rotating detonation combustor of claim 11, wherein the first fluid plenum wall is disposed radially inward of the radially inner wall; and wherein the second fluid plenum wall is disposed radially outward of the radially outer wall.
